(19) United States
(12) Patent Application Publication
(10) Pub. No.: US 2018/0025417 A1
(43) Pub. Date: Jan. 25, 2018

(54) Method and system for managing integrated online logistics

(71) Applicant: Loadexpress, Inc., San Diego, CA (US)

(72) Inventors: Rudy Brathwaite, San Diego, CA (US); Kent Qing Pu, Santa Fe, CA (US); Ivan Angelov, San Diego, CA (US)

(21) Appl. No.: 15/215,539

(22) Filed: Jul. 20, 2016

(51) Int. Cl. G06Q 30/08; G06Q 30/02; G06Q 10/08

(52) U.S. Cl. CPC G06Q 30/08; G06Q 10/0835; G06Q 30/0269

(57) ABSTRACT

Techniques related to logistics management between two parties are described. According to one aspect of the present invention, a platform or a marketplace is created for shippers and carriers to match the need of each other. A shipper has an item to be shipped from a pick-up address to a delivery address while a carrier has some remaining capacity in a trailer or container to accommodate the item. One of the advantages, benefits and objects in the present invention is to facilitate the shipper and the carrier to meet each other via the platform over the Internet through data aggregation and distribution.

### BACKGROUND OF THE INVENTION

### Field of the Invention

The present invention is generally related to the area of data aggregation and distribution over the Internet. Particularly, the present invention is related to techniques for managing integrated online logistics based upon the aggregated and distributed data. More particularly, the present invention is related to techniques implemented on computing devices for seamlessly enabling shippers and transportation carriers to conduct their business through an integrated online logistics marketplace.

### Description of the Related Art

Freight transport is a physical process of transporting goods from one place to another. The term shipping is originally referred to transport by sea, but is now extended to refer to transport by land or air as well. Logistics, a term originated from the military environment, is also fashionably used in the same sense. Regardless of what the transporting process is called, goods must be moved around to energize the economy. Land or ground shipping can be by train or by truck. In air and sea shipments, ground transport is required to take the cargo from its place of origin to the airport or seaport and then to its destination. Ground shipping is fundamental to the shipping industry.

Today, about 90% of non-bulk cargo worldwide is transported in trailers or containers of standard sizes. LCL and FCL are two of common terms used in container shipping. LCL means less container load versus full container load (FCL). If a shipper does not have enough goods to fill up in a full container, it would be efficient and cost effective to share the capacity of the container with other shippers.

The logistics industry is generally laggard in technology adoption. Much of the business is conducted via brokers with a combination of multiple software programs, facsimile, telephone calls and even paper, resulting in a haphazard and error-prone process that takes a lot of time, requires excessive human labor, and therefore is highly inefficient and costly. Thus there is a need for a mechanism to effectively aggregate information online from different sources including data on shipping capacities, types of containers to be used by different freight companies and needs by different shippers.

Based on a planned route and available capacity (e.g., remaining space in a container), a shipping carrier or a primary shipper booking an entire may want to share the cost with one or more secondary shippers to accommodate their goods in the available space of the truck/trailer. Thus there is another need for a shipper to engage with as many carriers as possible to utilize the available capacity in a container scheduled for a destination substantially close to a delivery address specified by the shipper. Similarly, there is yet another need for a carrier to engage with as many shippers as possible to fulfill an available space in a container scheduled for a destination without detour or with little detour. Further, there is yet another need to create a marketplace for shippers and carriers to match the need of each other, and a mechanism for both sides to bid against each other.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to an online platform that allows shippers and carriers to conduct their business with each other via data communication between two or more computing devices directly or via a centralized server. According to one aspect of the present invention, an online marketplace is created for shippers and carriers to match the need of each other and enables them to initiate and complete a transaction entirely within the marketplace, from posting, searching for and booking a shipment, to tracking shipment en route, to paying for the job and resolving disputes if any.

According to one aspect of the present invention, a mechanism is provided to aggregate from carriers various data about their available capacity of different types of trucks and trailer, such as spaces in trailers or containers for accommodating relatively small amount of freight from others to share the transportation costs. The mechanism is designed to distribute such data to shippers looking for such available capacity to transport their shipments.

According to another aspect of the present invention, a mechanism is provided to aggregate from shippers various shipping requests looking for available capacity in a trailer or container to transport their goods. The mechanism distributes such shipping requests to carriers willing to share their available capacity in trailers or containers for accommodating relatively small amount of freight from others to maximize the use of the containers or to share the transportation costs.

According to still another aspect of the present invention, a mechanism is provided to match both sides by way of a bidding process. The bidding process may be managed to continue with modified terms in a shipping request by a shipper or a counter-proposal by a carrier.

According to yet another aspect of the present invention, a shipment from a shipper may be picked up and delivered by an individual driving a car (e.g., a passage car), where the car is limited to a predefined capacity. Instead of a carrier operating a shipping company, the individual may participate on the platform to take on an opportunity to deliver the shipment for the shipper. The individual may continue to add one or more additional loads to his vehicle if he feels that the capacity of his car is not fully utilized. As his vehicle goes on, he may deliver one package, pick up another one to fill in the remaining capacity in his car, and continue the delivery process by periodically taking an appropriate shipping request from the platform.

The present invention may be implemented as an apparatus, a method, a system or a platform, each yields a different result. According to one embodiment, the present invention is a method for facilitating a shipper and a carrier to reach a deal online, the method comprises: sending out a shipping request from a first computing device associated with the shipper, wherein the first computing device executes a client module specifically designed to receive inputs from the shipper. The inputs include a pick-up address and a delivery address, a fee, weight and estimated space information and desired condition to handle a shipment from the shipper. The client module formulates the shipping request by including the inputs from the shipper and a time-sensitive deadline. The method further comprises receiving at least one bid from the carrier expressing a desire to transport the shipment, wherein the bid is a full acceptance of the shipping request or the bid is a counter offer from the carrier. The counter offer includes at least an amendment to some of the inputs from the shipper, causing the shipper to view the bid, and confirming the bid when the shipper agrees with the bid.

According to another embodiment, the present invention is a computing device for facilitating a shipper and a carrier to reach a deal, the computing device comprises: a display screen; a memory for storing a module; a processor, coupled to the memory, caused to execute the module to perform certain operations. The operations includes sending out a shipping request from the computing device associated with the shipper, wherein the computing device receives inputs from the shipper, the inputs include a pick-up address and a delivery address, a fee, a profile of a shipment with a desired condition to handle the shipment from the shipper, the shipping request is then formulated by including the inputs from the shipper and a timely-sensitive deadline; receiving at least one bid from the carrier expressing an interest to transport the shipment, wherein the bid is a full acceptance of the shipping request or the bid is a counter offer from the carrier, the counter offer includes at least an amendment to some of the inputs from the shipper; causing the shipper to view the bid; and confirming the bid when the shipper agrees with the bid.

One of the objects, features, and advantages of the present invention is to provide a platform or a marketplace for shippers and carriers to match the need of each other.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows a basic system configuration in which the present invention may be practiced in accordance with one embodiment thereof;

FIG. 1B, it illustrates an internal functional block diagram of a mobile device that may be used as a client device in FIG. 1A;

FIG. 2A shows a logic relationship between a client and a server, or a shipper and a plurality of carriers, where the client represents one of many clients that are intended to communicate with the server;

FIG. 2B shows an exemplary user interface that may be generated by the client module of FIG. 1B;

FIG. 2C shows an exemplary interface provided to allow a shipper to specify some notes for the pick-up of his shipment;

FIG. 2D shows an exemplary user interface provided to allow a shipper to specify a delivery address and what needed to know about the delivery by a carrier;

FIG. 2E and FIG. 2F each show an exemplary overview summarizing a portion of a shipping request entered by a shipper;

FIG. 2G shows an exemplary display that may be displayed on a computing device used by a shipper;

FIG. 3A shows an exemplary display generated by a client module (e.g., the client module of FIG. 3B) when a carrier operates a computing device executing the client module;

FIG. 3B shows an exemplary display of a selected shipping request from a shipper;

FIG. 3C shows a display to allow a carrier to do some calculations to determine what is the cost and the approximated profit he could make should he decide to take on the shipment;

FIG. 3D illustrates a display to summarize a bid with a lowest bid the carrier could accept.

FIG. 4A shows a flowchart or process of distributing a shipping request by a shipper using a computing device executing a uniquely designed client module;

FIG. 4B shows a flowchart or process of making a bid by a carrier to a shipping request from a shipper;

FIG. 4C shows an example of road conditions for a shipment going through;

FIG. 4D shows a map with two routes A and B from San Diego, Calif. to Chicago, Ill.;

FIG. 4E shows an exemplary profile of energy use through the uphill up to 11000 ft;

FIG. 4F shows a corresponding profile of energy use corresponding to a route in FIG. 4D; and

FIG. 5 shows a functional block diagram of a server in which a server module resides in a memory space and is executed by one or more processors therein.

### DETAILED DESCRIPTION OF THE PREFERRED EMBODIMENTS

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

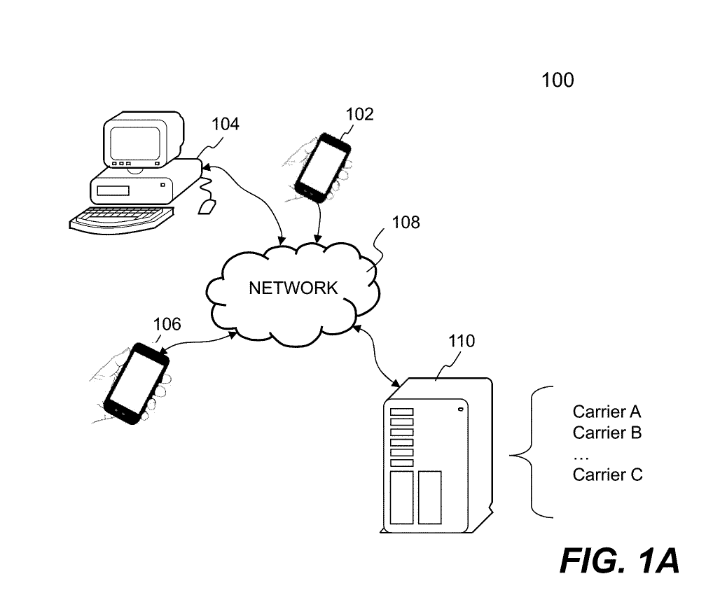

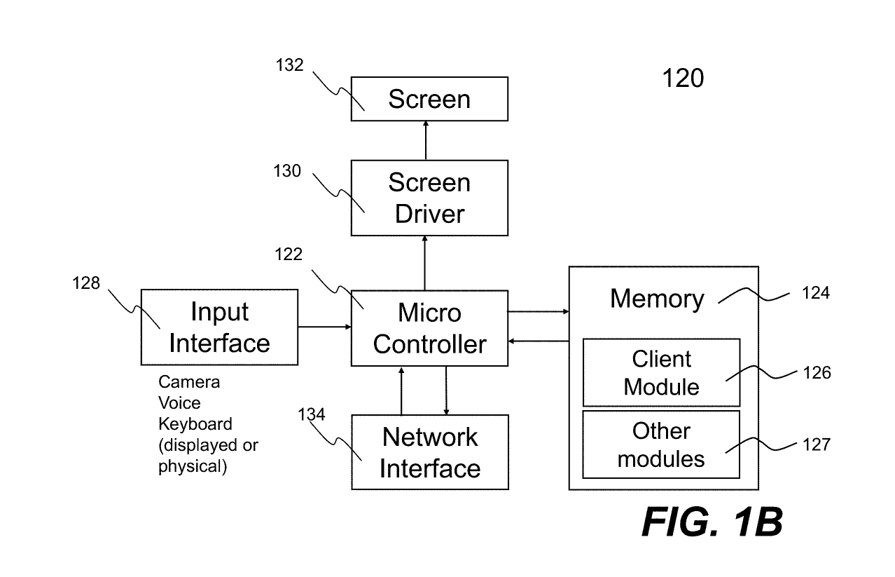

The present invention pertains to a system, a method, a platform and an application each of which is invented, uniquely designed, implemented or configured to cause a computing device by a shipper to communicate with a plurality of computing devices by different carriers, where the carriers can see what a shipper is looking for and what the carriers can offer. Referring now to the drawings, in which like numerals refer to like parts throughout the several views. FIG. 1A shows a basic system configuration 100 in which the present invention may be practiced in accordance with one embodiment thereof. FIG. 1A shows that there are three representative computing devices 102. 104 and 106, where the device 102 or 106 is meant to be a mobile device (e.g., a wearable device, a smart phone, a tablet or a laptop) while the device 104 is meant to represent a stationary device (e.g., a desktop computer). Each of the devices 102, 104 and 106 is loaded with a program, an application or a client module. In particular, each of the devices 102, 104 and 106 is associated with a user (e.g., a shipper or a carrier), some of the devices 102, 104 and 106 are preferably to have a touch-screen display, as most of the mobile devices do. Although other man-machine interfaces are possible, a touch-screen display provides the convenience for a user to interact with the display of a message. Depending on the situation, a shipper may enter a description of goods to be shipped along with a destination and a desired fee hs is willing to pay for or a shipper may bid for the opportunity to ship the goods at a mutually agreed cost by the shipper or counter a revised offer.

The server device 110 represents one or more servers provided to bridge carriers and shippers. It should be noted that a carrier herein may mean a shipping operator, a dealer, a company, a business or an individual. In one example for the purpose of reducing the shipping cost, a business or an individual that has booked an entire trailer or container, hence a primary shipper, desires to share the trailer or container with another shipper or other shippers. Similarly, to help shippers save money, a dealer may resale the available space in a trailer or container to retail shippers. To facilitate the understanding of the present invention, unless specifically stated, the word “carrier” or “carriers” are used to represent an entity capable of delivering or arranging the delivery of a shipment. According to one embodiment, the server device 110 is provided for a shipper, via one of the computing devices 102. 104 and 106, to engage with a selected carrier among others to accommodate the shipper's goods to his desired destination. According to another embodiment, the server device 110 is provided to aggregate data or information from carriers about their capacity and availability during a particular time period (e.g., in next few days or in the next two or three weeks). Depending on an implementation, the aggregated information from the carriers registered with the server 110 may include respective routes/destinations their shipments are scheduled to go, sizes of available spaces in their scheduled trailers or containers, a rate for a volume, weight, a wholesale price, and etc.

As will be further detailed herein, one embodiment shown in FIG. 1A includes the server 110 executing a server module in data communication with a plurality of clients 102. 104 and 106, each of the clients 102. 104 and 106 executing a client module, where the server module or the client module implements specific functions to facilitate how a shipper to engage with a selected carrier among others to accommodate his goods to his desired destination, preferably per a mutually agreed arrangement (e.g., where to pick up and delivery, costs, and days to ship, etc.), where these specific functions are not generally available on a generic computer.

Referring now to FIG. 1B, it illustrates an internal functional block diagram 120 of an exemplary mobile or computing device that may be used as a client in FIG. 1A. The device 120 includes a microprocessor or microcontroller 122, a memory space 124 (e.g., RAM or flash memory) in which there is a client module 126 loaded, an input interface, a screen driver 130 to drive a display screen 132 and a network interface 134. The client module 126 may be implemented as an application implementing one embodiment of the present invention, and downloadable over a network from a library (e.g., Apple Store) or a designated server.

The input interface 128 includes one or more input mechanisms. A user may use an input mechanism to interact with the device 120 by entering a command to the microcontroller 122. Examples of the input mechanisms include a microphone to receive an audio command and a keyboard (e.g., a displayed soft keyboard) to receive a click or texture command. Another example of an input mechanism is a camera provided to capture a photo or video, where the data for the photo or video is stored in the device for immediate or subsequent use with other module(s) or application(s) 127. In one embodiment, one or more photos of the shipment from a shipper is taken with the camera, where the photos are uploaded and sent to a carrier in discussion of making an arrangement of transporting the shipment. The photos allow the carrier to view if the shipment is properly packed, whether it looks acceptable to be transported with other goods in a trailer or container the carrier has planned.

The driver 130, coupled to the microcontroller 122, is provided to take instructions therefrom to drive the display screen 132. In one embodiment, the driver 130 is caused to drive the display screen 132 to display an image or images (e.g., forms, shipping requests from shippers or advertisements form carriers) or play back a video (e.g., a loading or delivery clip for the shipper to show how the shipment is being handled or a video clip to show how the shipment looks or packed). The network interface 134 is provided to allow the device 120 to communicate with other devices via a designated medium (e.g., a data network or the Internet).

According to one implementation, the client module 126 is loaded in the memory 124 and executed by the controller 122 to provide functions used by a shipper or a carrier. For examine, in the case for a shipper, the client module 126 allows the shipper to place a shipping request, receive a bid or an agreed bid from a carrier, receive a pick-up and a delivery notification from the carrier via the device 120, In one embodiment, the client module 126 is designed to communicate with a designated server to track where his shipment is during transit after it was picked up by the carrier. In the case for a carrier, the client module 126 allows the carrier to receive a shipping request from a shipper, place a bid if the carrier is determined to take on the goods from the shipper in one of the scheduled trailers or containers going to the same destination or a place near the destination. In one embodiment, the client module 126 is designed to automatically match a container among others that is best to accommodate the goods.

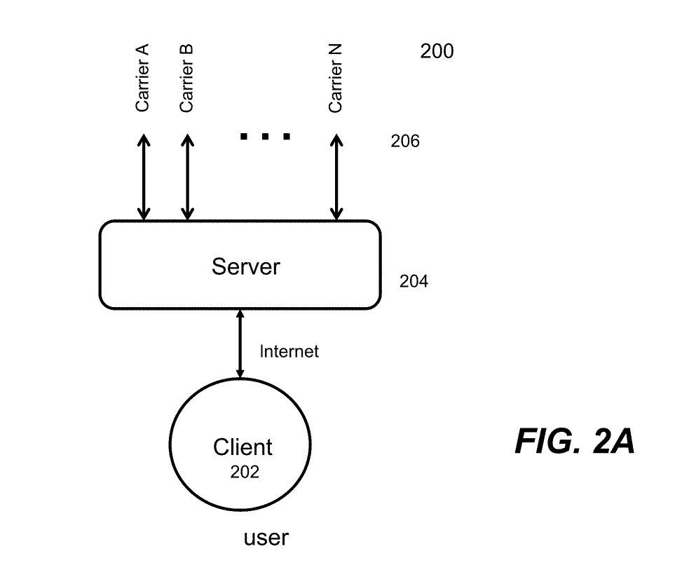

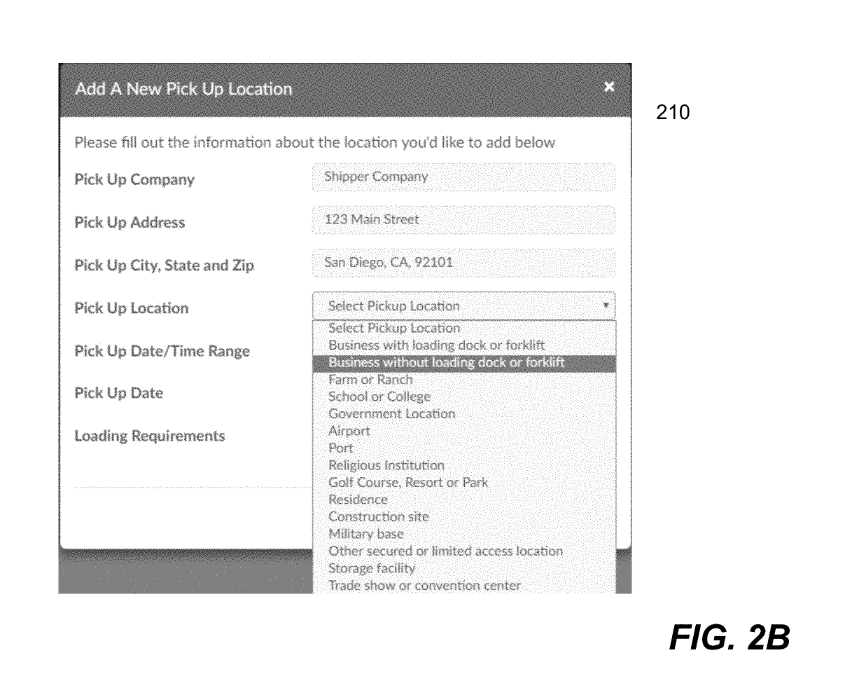

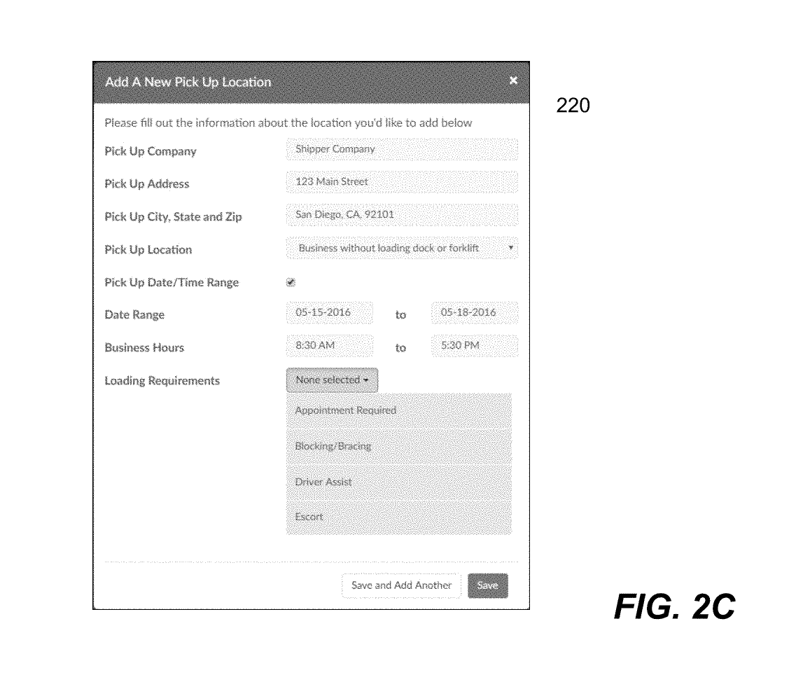

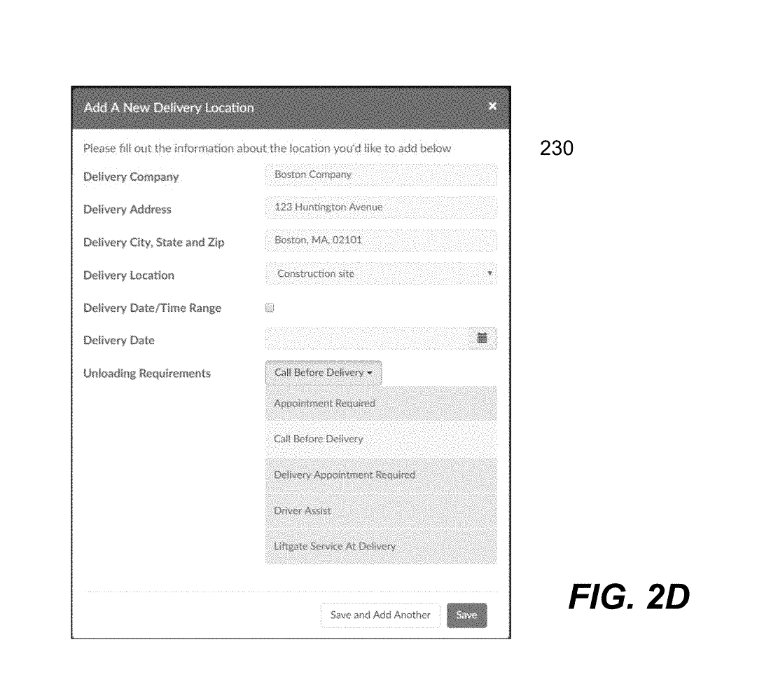

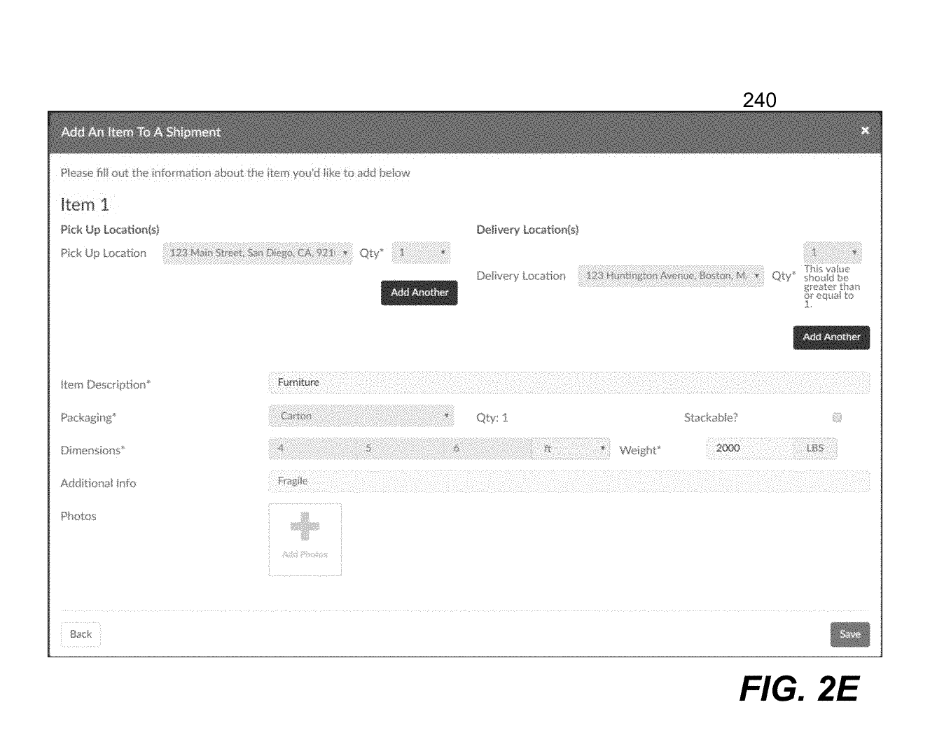

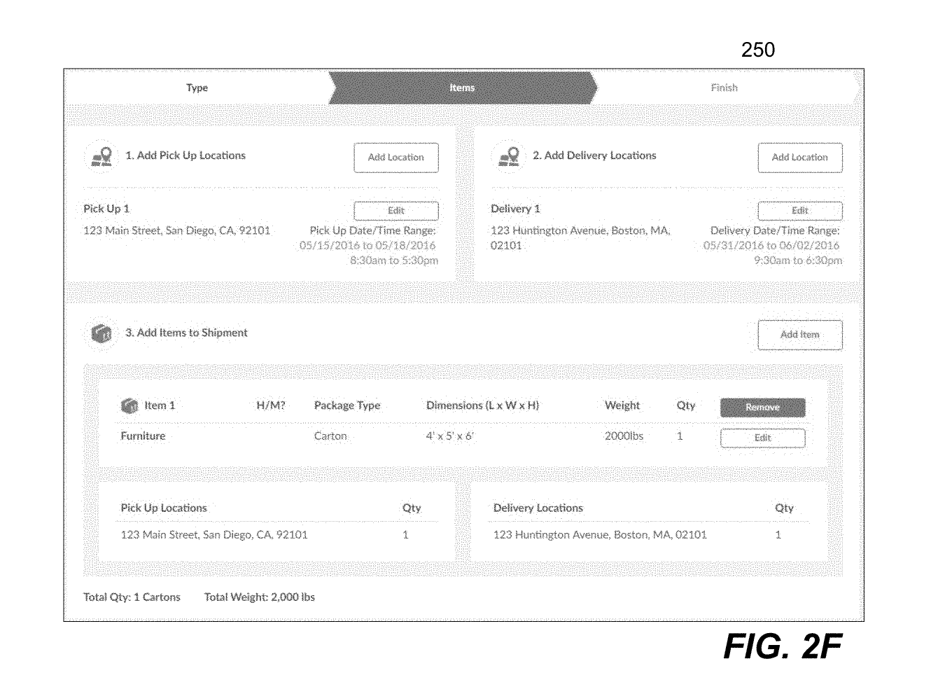

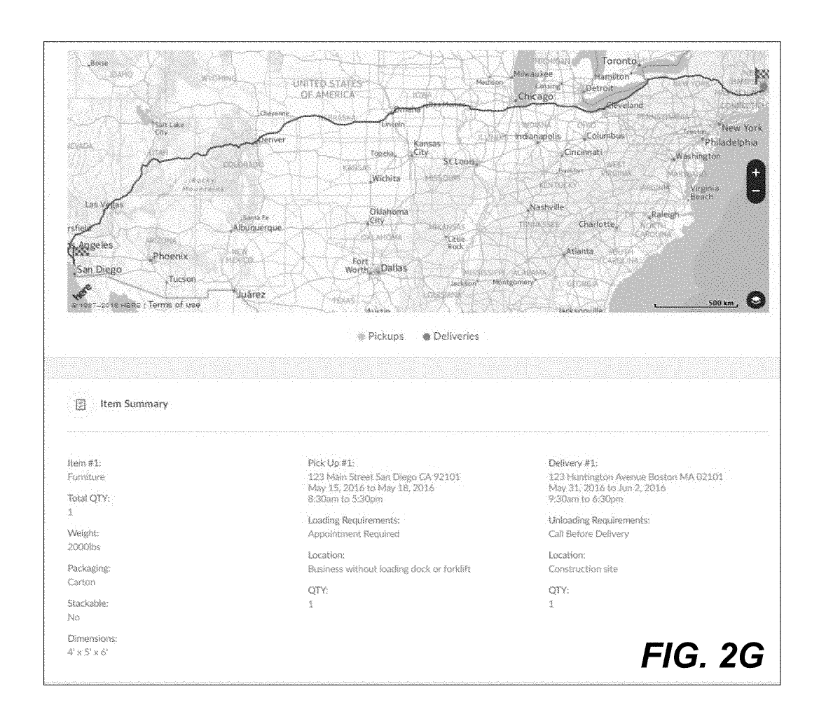

Referring now to FIG. 2A, it shows a logic relationship 200 between a client 202 and a server 204. The client 202 represents one of many computing devices associated with shippers that are intended to communicate with the server 204. When a shipper is ready to ship one or more items that together take far less space than what a standard trailer or container is designed to accommodate, it would be much more cost effective if the items are shipped by sharing a container with other shippers or a primary shipper of the container. But in general, the shipper would not know which carrier would have such a freight and whether the freight would go in the same direction even if there was one available. Once of the advantages, benefits and objects in the present invention is to provide a mechanism that brings the shippers and carriers together to a platform to allow a shipper to communicate with all interested carriers. Based upon what the shipper needs, each of the carriers decides whether to accommodate the shipment from the shipper and competes for the opportunity when there are more than one carriers wanting the opportunity.

FIG. 2B shows an exemplary user interface 210 that may be generated by the client module 126 of FIG. 1B. The interface 210 is provided to allow a user or a shipper to specify a shipping address and describes a site for pick-up so that a carrier knows whether it can arrange the pick-up given the condition of the site. The interface 220 shown in FIG. 2C is provided to allow the shipper to specify some notes for the pick-up. Depending on an implementation, the notes may include a specified time/date range for the pick-up and a desired approach for handling the pick-up (shown in FIG. 2C), and/or other notes the shipper hopes a carrier to know (e.g., a nearby street) before making a bid for the shipment by the shipper. FIG. 2D shows an exemplary user interface 230 provided to allow the user to specify a delivery address and what is needed to know about the delivery by a carrier.

Not explicitly shown in the figures, the user may also describe what goods are to be shipped. The information provided by the user may include the content, approximate size or volume and weight, how they are packed, any cautions in handling the content or goods, a preferable route and etc. Additionally, the shipper may even provide what cost or a range of costs he is willing to pay or share with a primary shipper of the trailer or container or the carrier. The purpose is to have the shipper provide as much useful information as possible so that the primary shipper or the carrier can judge whether to take on the opportunity, perhaps with a scheduled freight. FIG. 2E and FIG. 2F show an exemplary overview 240 summarizing a portion of a shipping request entered or formulated by the shipper.

Accordingly to one embodiment, the client module 126 of FIG. 1B is designed to generate a geographic map with a route from the entered pick-up address to the entered delivery address so that the user can verify visually whether all address information looks correct or specify an alternative route. On the other end, the displayed route may help a carrier determine visually or graphically whether the displayed route matches a route a trailer is planned to go. In the event, the displayed route is altered by the user, the carrier can determine how much impact the modified route would have on the planned route for the freight originally scheduled. FIG. 2G shows an exemplary route that may be displayed on a computing device used by the shipper or a carrier interested in the shipping request from the shipper.

In reference to FIG. 2A, the shipping request is sent out from the client 202 to the server 204, where the server 204 executing a server module to distribute the request to those registered carriers. As will be further described herein, the server module is specially designed according to one embodiment of the present invention, to cause the server to communicate with the client 202 and distribute the shipping request to a number of registered carriers to bid for the shipping request (i.e., an opportunity).

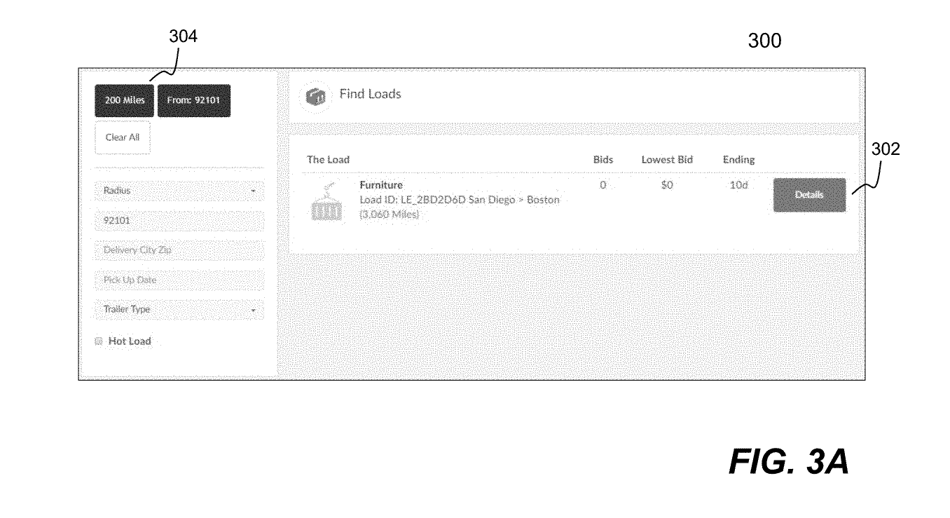

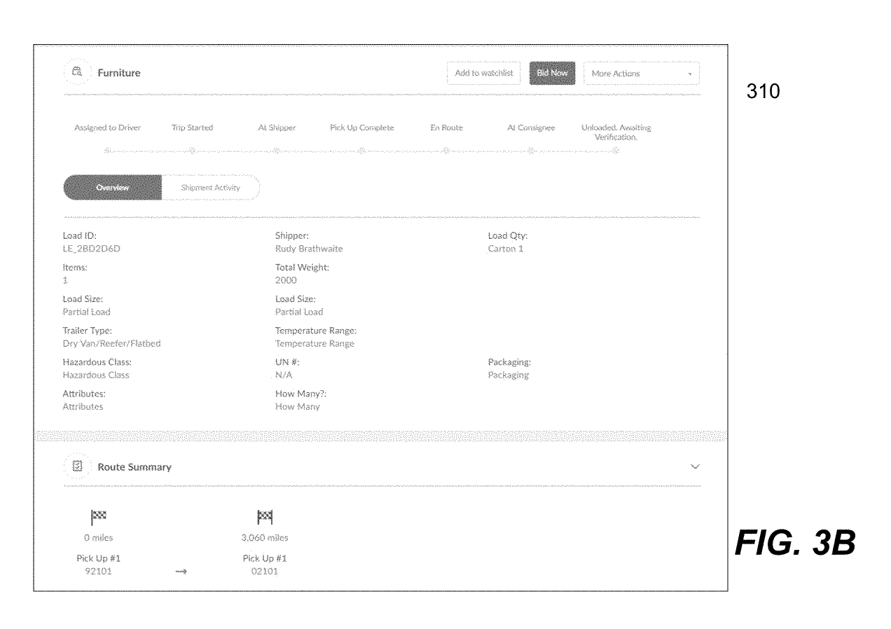

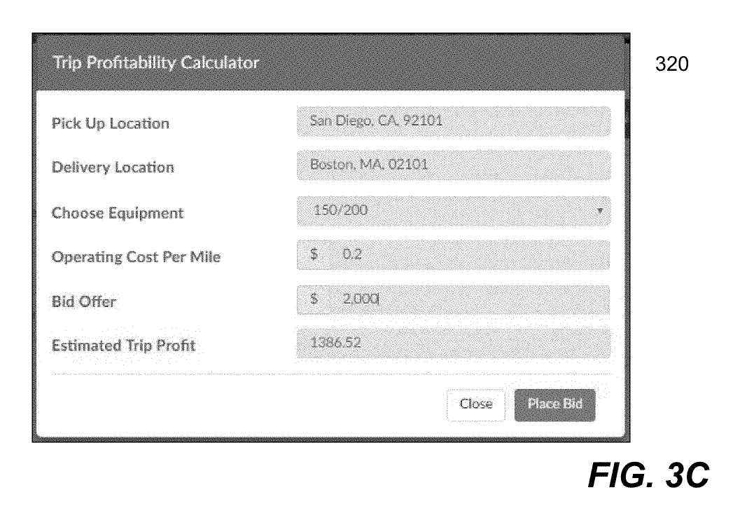

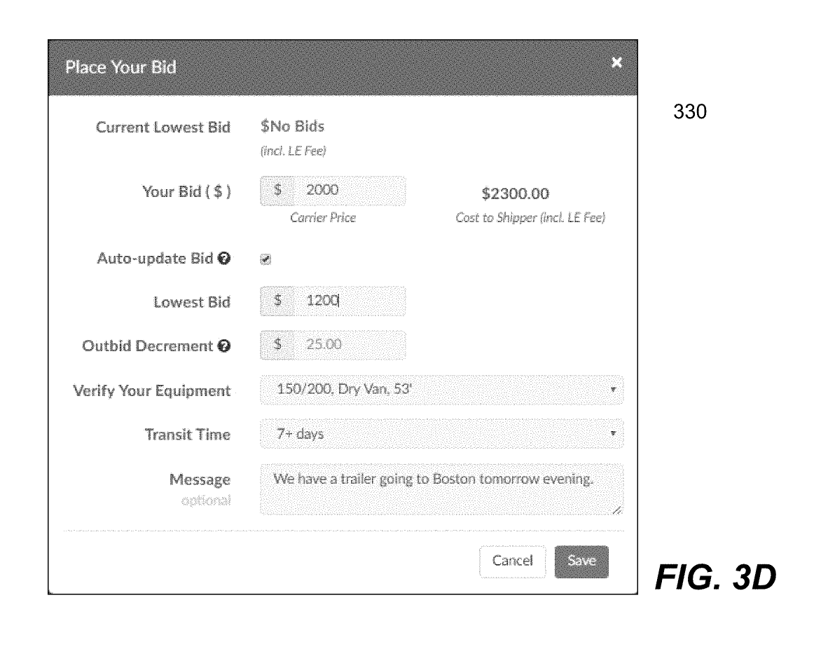

Referring to FIG. 3A, it shows an exemplary display 300 generated by a client module (e.g., the client module 126 of FIG. 1B) when a carrier operates a computing device executing the client module. The display 300 shows that there is currently one shipping request 302 given the conditions 304 defined by the carrier. The conditions 304 include a distance within which the carrier is willing to go for picking up a shipment. Depending on an implementation, the conditions 304 may also include a zip code within which the carrier can go to pick up the shipment, and/or a type of trailer or container the carrier has. For example, if the shipment requires a type of container different from what the carrier has, the carrier may not want to bid for the shipment. Essentially, the display 300 shows how many available shipping requests from those shippers who desire LCL shipments per the conditions defined by the carrier. When the conditions are modified or relaxed (e.g., the carrier is willing to take on a shipment along the route the freight is going or take a small detour, in which case the radius from the carrier could be expanded significantly), the carrier may see more shipping requests from those LCL shippers.

When the carrier clicks the details 302 to see the details of the shipping request, FIG. 3B shows an exemplary display 310 of the selected shipping request from a shipper. This allows the carrier to judge whether he has the necessary equipment/condition to pick up, move and deliver the shipment to meet the needs of the shipper. As an example, FIG. 3C shows a display 320 to allow the carrier to do some calculations to determine what is the approximated profit he could make should he decide to take on the shipment. Depending on the implementation, various data may be imported to assist the calculations. For example, a set of data can be used to show how far the delivery address is from the originally planned route, whether the shipment can be delivered without detour or with little detour, what the variations of the gas price are along the route. According to one embodiment, the terrains are also considered as the uphill costs more than the downhill. In another embodiment related to a trailer driven electrically, the usage of electric power is calculated due to the additional weight from the shipment.

Depending on an implementation, various parameters may be included to assist a carrier to determine the costs or profit so as to conclude whether to take on the LCL shipment. Some of the parameters will be further described herein. In any case, from the calculations, the carrier can determine a minimum charge of transporting the shipment along a planned route. In general, any charge above the minimum charge is a profit. If the proposed fee by the shipper is significantly greater than the minimum charge, the carrier may simply accept the shipping request as is provided the carrier can handle the delivery. Otherwise, the carrier may counter a proposed bid with modified terms or fees. To prevent the shipper from accepting a bid from a competing carrier, a bid may be made to automatically reduce the charge by a fixed amount when there are one or more other carriers expressing an interest to make a bid to the shipping request from shipper. FIG. 3D illustrates a display 330 to summarize a bid with a lowest bid the carrier could accept.

According to one embodiment, the carrier can write up his bid entirely against the shipping request for the shipper to consider. In any case, when there are more than two carriers interested in taking on the shipment, the bid that is set to automatically decrease the biding price by a fixed amount (e.g., $25 as exampled in FIG. 3D) to the lowest bid wins. Once the shipper accepts the bid, the carrier and the shipper arrange a time range to pick up the shipment. In general, the carrier can track the shipment and receive the status of the shipment from his driver or the GPS system equipped in the trailer.

According to one embodiment, the client module in the computing device used by the shipper is designed to retrieve the status report from the carrier by way of data communication between the two devices used by the shipper and the carrier. In one case, the carrier notifies the shipper periodically about the status of his shipment. In another case, the carrier allows the shipper to monitor graphically his shipment on a displayed map. Depending on the situation or the relationship between the shipper and the carrier, the shipper may have to pay some or all of the cost to the carrier before the carrier comes to get the shipment, during the transit or after the shipment is delivered.

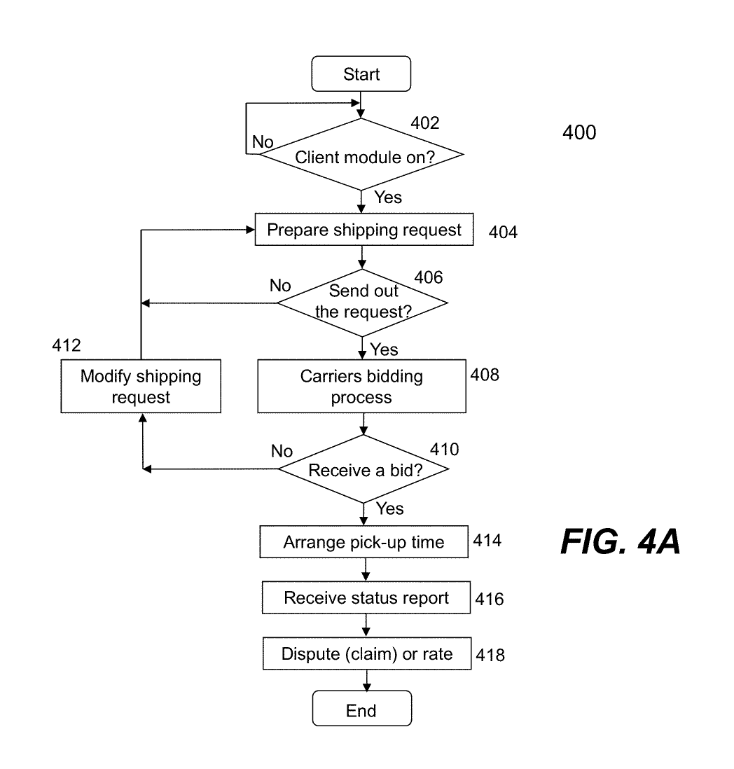

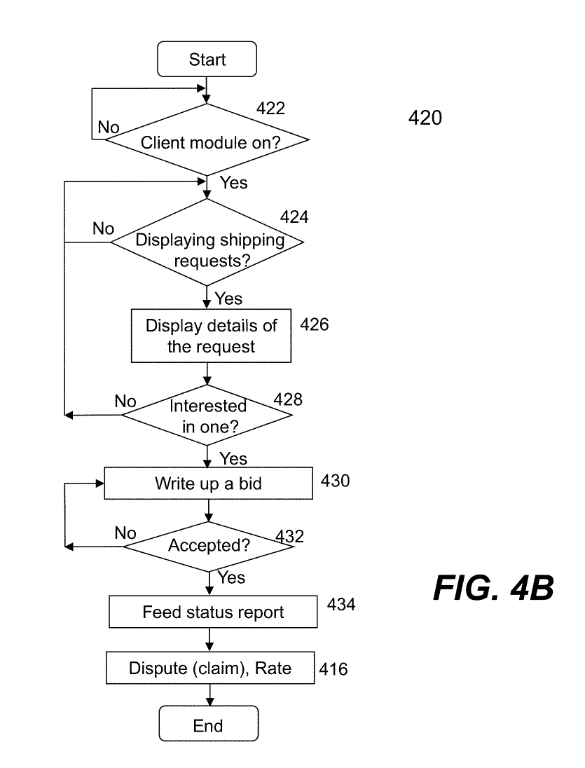

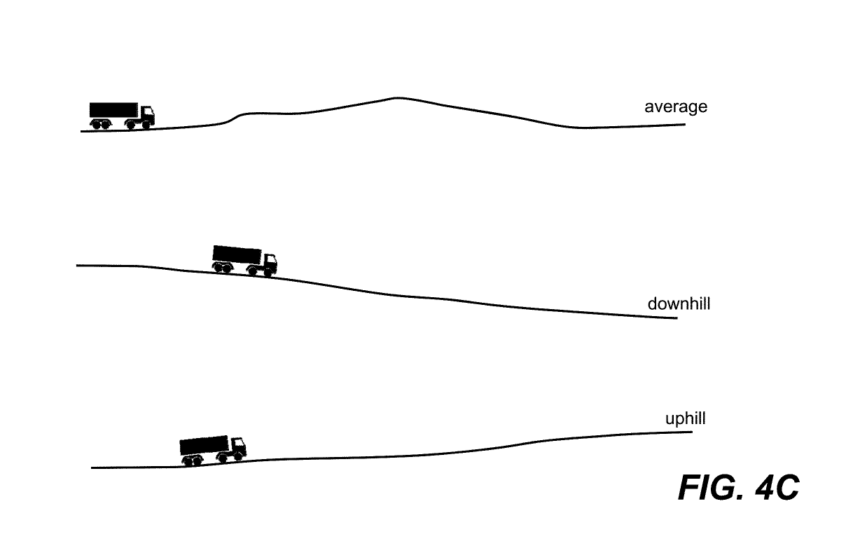

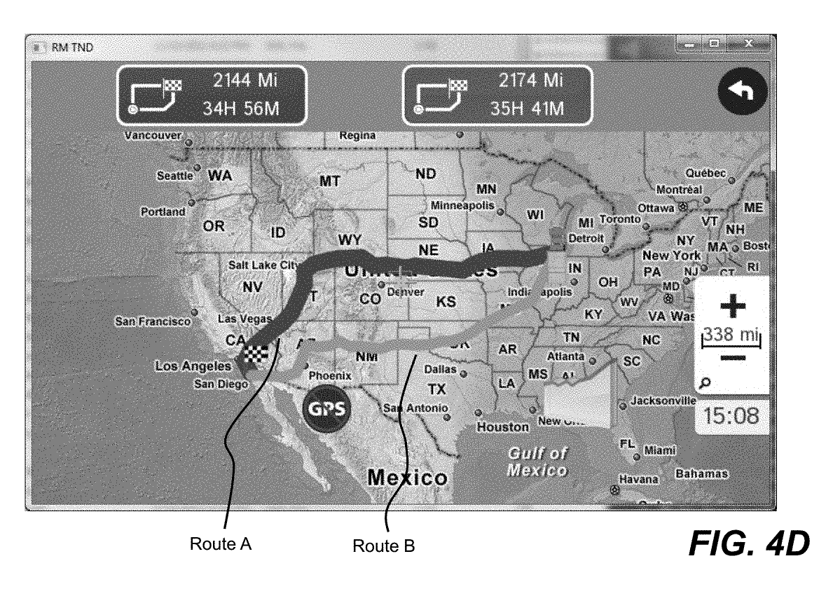

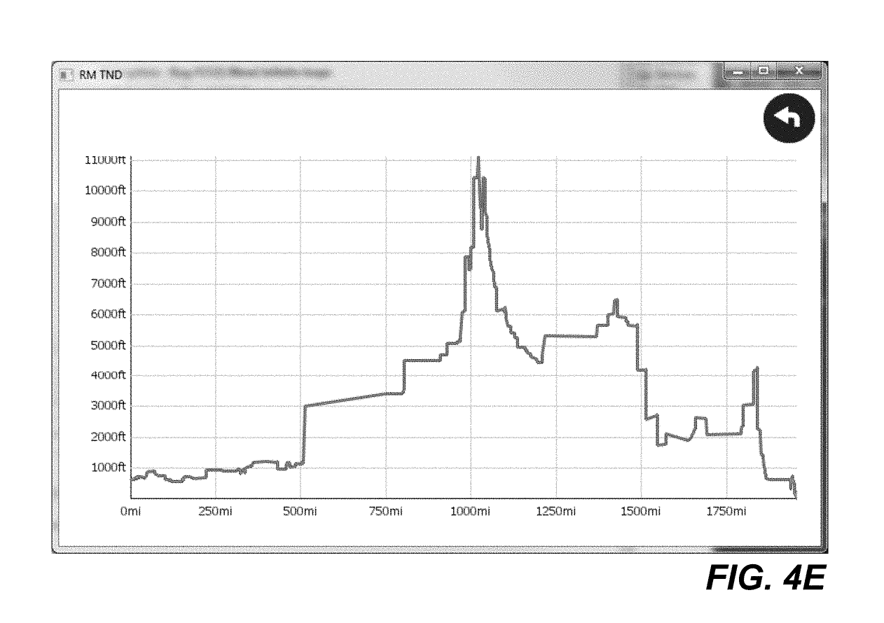

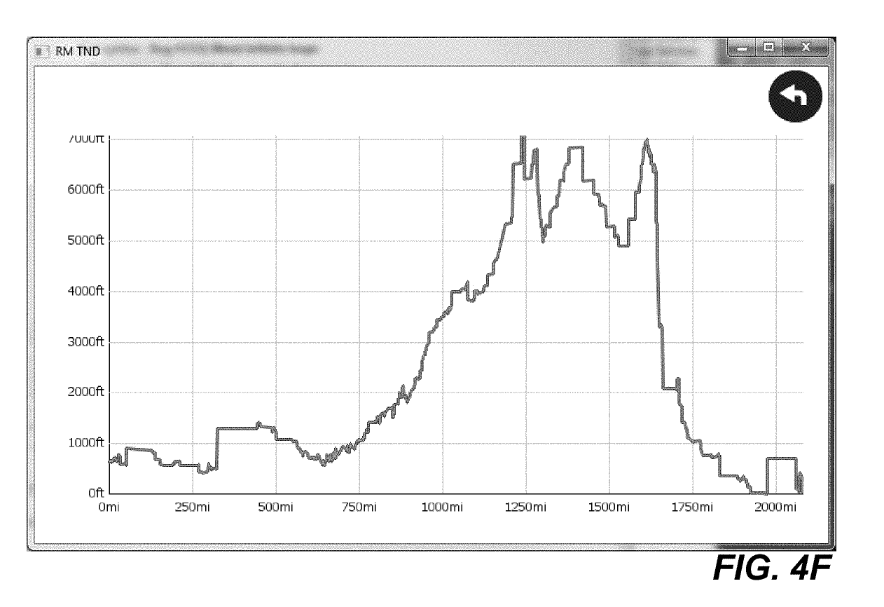

Referring now to FIG. 4A and FIG. 4B, it shows a flowchart or process 400 of distributing a shipping request by a shipper using a computing device executing a uniquely designed client module, and the other shows a flowchart or process 420 of making a bid by a carrier to the shipping request from a shipper. The process 400 or 420 represents some of the functions performed by the client module. As appreciated by those skilled in the art, the process 400 or 420 is not something a generic computer is capable of performing by itself. A generic computer must be specifically programmed or installed with the specifically designed module according to one embodiment of the present invention. As will be further demonstrated, it is practically impossible for the process 400 or 420 interacting between two computing devices via a server in its entirety to be performed by or to have the intervention of human beings.

With the execution of a client module or a server module implementing one embodiment of the present invention, the two computing devices are caused to perform beyond what they are originally designed for or meant to do. Each of the processes 400 and 420 may be understood in conjunction with the preceding drawings. Each of the processes 400 and 420 may be implemented in software or a combination of software and hardware.

It is assumed that a user is using a client (e.g., a smartphone, a tablet or a computer) that has been installed with a client module (e.g., the module 126 of FIG. 1B). The module is activated manually or automatically upon an event (e.g., a shipper desires to look for a carrier that is registered to share some available space in a trailer going to the same direction). At 402, the process 400 can proceed when the module is running. Depending on the situation, the shipper may manually activate the client module by clicking on an icon or link representing the client module or the client module is automatically activated by an application, a webpage being visited, a stored cookie or at a specific time.

The process 400 proceeds to 404 where a shipping request is prepared. As described above, the shipper needs to tell a carrier what he is shipping, from where to where, approximated weight and any cautions or needs when transporting or handling the shipment. In addition, the shipper may add notes to tell a carrier any potential restrictions/conditions the carrier needs to be aware of. According to one embodiment, the shipper may specify how much he is willing to pay for the shipment. According to another embodiment, the shipper may add a range of cost he is willing to pay, in which case the client module is designed to automatically decrease or increase the initially specified amount by an amount on behalf of the shipper when there is no response from a carrier or there are more than one carriers interested in transporting his shipment.

It is assumed now that the shipping request is done by the shipper. The process 400 goes to 406, where the client module is designed to distribute the shipping request to all carriers that have requested to receive such a shipping request. According to one embodiment, the request is sent to a server (e.g., the server 110 of FIG. 1A). The server executes a server module that maintains a database recording all registered carriers or large (primary) shippers that are willing to share their available spaces in containers that have been booked. In one embodiment, these registered carriers may register their available spaces, trailer or container types, routes, destinations, date ranges, costs and/or other information with the server to allow shippers to see what is available to meet their needs.

Once the shipping request is distributed at 408, the process 400 goes 410 to wait for an interested carrier to respond to the shipping request. As will be further described in FIG. 4B, a carrier needs to verify what equipment he has and whether they match the condition to transport the shipment. If the carrier does not have the capacity (e.g., space or weight limit) available to accommodate the shipment, the carrier will check out another shipping request. It is now assumed that the shipping request distributed at 408 receives no bid from any of the registered carriers for various reasons (e.g., the cost provided by the shipper is hardly justified, too many restrictions, not worth the trouble or the originally planned route has to be altered too much, etc). The process 400 goes to 412, where the shipper may have to modify the shipping request to relax some of the restrictions, increase the sharing cost, split one shipment to two or more shipments, or give more flexibility in time for pick-up and delivery and etc. so that more carriers may accommodate the his needs. Once the shipping request is modified, the newly updated shipping request at 404 is distributed again at 406. Accordingly, all the carriers get a chance to review the modified request at 408. In the event, the original request has not been accessed by a carrier, the original request shall be updated to avoid an impression of two separate requests from the same shipper. Again, the fee the shipper is willing to pay in the modified request may be automatically adjusted upwards or downwards when there are more than one bids for the shipping request or when there is still not a bid.

It is now assumed that there is one bid from 410. At this point, the shipper and the carrier that made the bid are connected. The process 400 goes to 414, where the shipper and the carrier can arrange a mutual convenient time for the carrier to pick up the goods from a location specified by the shipper. In one embodiment, the carrier includes a predefined time to pick up the shipment from the shipper, where the predefined time has been included as an anticipated cost to the task. However, there could be some unanticipated events or conditions that might go beyond the estimate of the carrier. For example, when a trailer arrives, the shipper is still in the middle of packaging the shipment. In another case, the movement of the shipment to the trailer meets some difficulty, for example, there are obstacles in the way. Such unanticipated events or conditions could also happen at delivery. All of these unanticipated events or conditions could impede the task completion, resulting in an unexpected loss to the carrier. Thus, the carrier has an option to charge the shipper for the extra time needed to complete the shipping request from the shipper. This added-on option may be included in a counter-proposal or a bid to the shipper. Alternatively, charges for unexpected time needed to complete the pick-up or delivery.

Once the shipment is picked up by the carrier, the shipper can receive a status report from the carrier at 416. Depending on the implementation, the carrier may provide a link to the shipper to see where his shipment is at a time so that the shipper knows exactly where his shipment is located. In additional, the shipper is notified electronically that his shipment has been delivered and signed off. In one embodiment, the shipper or the consignee is offered an option at 418 if he has anything to report to the shipper. For example, if the shipment is delivered with something missing or damaged, the shipper can file a claim for compensation at 418, otherwise the shipper can rate the service provided by the carrier so that the carrier is labeled with a rank (e.g., 5-star, 4-start, etc.) which gives other potential shippers to consider when choosing a carrier among others.

FIG. 4B shows a flowchart or process 420 of making a bid by a carrier to a shipping request from a shipper. Similar to a shipper, a carrier uses a computing device (e.g., a smartphone, a tablet or a computer), where the computing device is loaded with a client module (e.g., the module 126 of FIG. 1B) and executes it at 422 before the process 420 can proceed.

At 424, the process 420 determines whether there is a shipping request. If no one has posted or distributed a shipping request, the process 420 awaits. It is assumed that the client module displays a list of shipping requests (assuming a number of shippers have posted or distributed their shipping requests). At 426, the carrier is able to view the details of each shipping request. In one embodiment, the carrier may enter some defined conditions, what he has or his capacity and availability (e.g., the types of trailers or containers he has or available capacity for LCL shipments during a period, a radius of area he is willing to go to pick up a shipment). As a result, the shipping requests displayed at 424 or 426 are only those that match the defined conditions by the carrier. Should the carrier relax some of the conditions, more shipping requests may be displayed. In another embodiment, the carrier may offer to pick up a shipment along a route a trailer goes. Instead of picking up a shipment at the origin of a route, the carrier may also pick up a shipment in the middle of the route, provided that the shipment fits well in the available capacity offered by the carrier. Those skilled in the art can appreciate that the available capacity may be reused along the planned route. In other words, a first shipment may be picked up and delivered at a first destination. After that, a next or second shipment may be picked up after the first shipment is delivered to use the same capacity again.

At 428, the carrier determines if a shipping requests interests him. If not, the carrier can view the next shipping request. It is assumed that the carrier is interested in one shipping request. The process 420 goes to 430, where the carrier responds to the shipping request. Depending on the detail of the shipping request, the profile of the load, his current and projected capacity and availability, the carrier writes up a bid, including increasing the offered fee by the shipper, a request to spilt a single shipment into two or more shipments to fit into the available space in a trailer going to a planned destination identical to or close to a destination specified by the shipper, a flexibility in delivery time, and etc. In the event, the price offered by the shipper is too low or there are too many carriers expressing their interests in the opportunity, the carrier may calculate his cost or/and profit separately based upon the road condition the shipment is going through.

FIG. 4C shows an example of road condition for the shipment going through. In general, the time or mileages a GPS device calculates or provided on the Internet is based on an average road condition. That means the road may have some ascending portions (uphill) or some descending portions (downhill), the consumptions of fuel or electrical energy on the two different terrains are very different. Should the carrier know the terrains very well between the pick-up address and the delivery address of the shipment, the carrier may do a much detailed calculation of the cost and profit. It is assumed that the road to deliver the shipment is all downhill, as shown in FIG. 4C, the carrier could write the bid up much more aggressively to win the opportunity. Otherwise, the carrier would write up the bid cautiously if the road to deliver the shipment is all uphill, as shown in FIG. 4C.

As stated above, there are a number of parameters that affect the calculation of the cost and profit by a carrier. One of the parameters is the gas tank weight that can be reduced by miles driving. Typically, a transportation truck is equipped with a huge gas tank, resulting in additional weight from the gas when the tank is filled up. The additional weight could is an addition to the overall cost when the truck is en route but is gradually reduced. Given the miles-per-gallon (MPG) for the truck and the terrains of the route, the formula MPG X Gas weight per gallon is used to derive the cost associated with transporting the LCL shipment.

Another one of the parameters is the time a driver needs to rest after a certain number of hours of driving. Most drivers must follow the HOS (Hours-of-Service) Regulations if they drive a commercial motor vehicle, or CMV. In general, a container or a trailer would be considered as a CMV. Various rules including the internal policy of the carrier limit the number of daily and weekly hours spent driving and working, and regulate the minimum amount of time a driver must spend resting between driving shifts.

Yet another one of the parameters is what is referred to as fuel economic routing based on the profile of energy use, applicable to any type of energy used to transport the shipments. FIG. 4D shows that there are two routes A and B from San Diego, Calif. to Chicago, Ill. Most trucker drivers prefer not to go though Denver, Colo., specially in winter time.

Geographically, route A would require a truck to ‘lift’ itself uphill, thus costing more energy. FIG. 4E shows a profile of energy use through the uphill up to 11000 ft. According to one embodiment, a module (either as part of the client module or the server module) is designed to find a route more efficient in energy use. The preferable route B shown in FIG. 4D includes less uphill (or less sharp upwards), thus reducing energy waste. FIG. 4F shows a corresponding profile of energy use.

In reality, the route B is about 30 miles longer than the route A, but needs to lift a truck (e.g., 80000 Lb load) from 5000 ft to 7000 ft 3 times while the route A needs to lift the same truck once from 5000 to 11000. It turns out that the energy consumption through the route B is less than the consumption through the route A. Further in the case of using gasoline, going through Texas is practically cost efficient because the price of gasoline in the southern states is normally lower than that in the northern states. Thus the route determination, the route terrains, weather conditions and even the energy cost along the route would be used by a carrier to effectively compete for the opportunity to take on the LCL shipment to reduce the cost of transporting an originally arranged shipment by utilizing the remaining capacity of the container or trailer.

Once the bid is prepared, the bid is sent back to the shipper. Depending on the bid and the number of bidders, the shipper can deny the bid or accept the bid. In the event, the shipper does not deny the bid but makes a counter offer, the process 420 goes back to 430, where the carrier may modify the bid till the negotiation reaches a mutually acceptable agreement. It is now assumed that bid from the carrier has been accepted by the shipper, and the shipper and the carrier have also made an arrangement as to when and how to pick up the shipment.

At 434, the carrier feeds a status report to the shipper from time to time to let the shipper know where his shipment is located and when the shipment is expected to arrive at the destination. It is assumed that the shipment has arrived and the shipper is also notified of the delivery status. At 416, the shipper has the opportunity to file a claim if the shipment is somewhat damaged. If everything goes through, the shipper can rate the carrier or the carrier can rate the shipper so that other potential shippers or carriers would know if they want to do business with the shipper or the carrier.

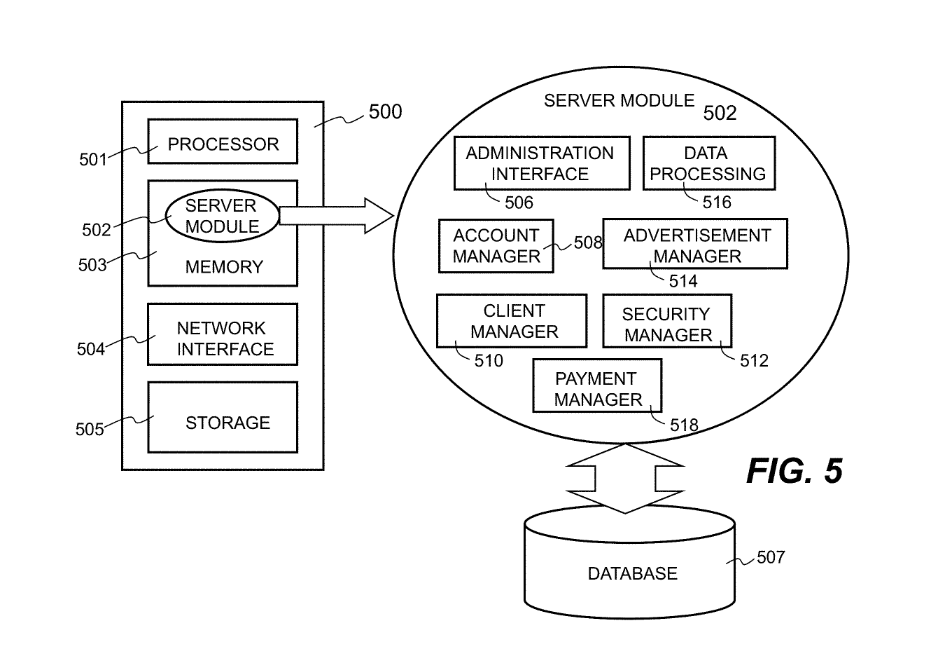

Referring now to FIG. 5, there is shown a functional block diagram of a server 500 in which a server module 502 resides in a memory space 503 and is executed by one or more processors 501. The server 500 is a representation of many similar servers operated by a service provider and may be used in FIG. 1A to facilitate the communication between shippers and carriers. In one embodiment, the server module 502 is implemented as part of or to expand the client module 126 of FIG. 1A, in which case, the computing device communicates with the carrier directly. The following description is based upon the exemplary configuration of FIG. 1A. Those skilled in the art shall appreciate that some parts of the functions being performed by the server module 502 may also be implemented in or performed by the client module 502.

Depending on the implementation, this server 500 may be a single server or a cluster of two or more servers. One embodiment of the present invention is implemented as cloud computing in which there are multiple computers or servers deployed to serve as many businesses or individuals as practically possible. For illustration purpose, a single server 500 is shown in FIG. 5. Further, the server 500 includes a network interface 504 to facilitate the communication between the server 500 and other devices on a network, and a storage space 505. In one embodiment, the server module 502 is an executable version of one embodiment of the present invention and delivers, when executed, some or all of the features/results contemplated in the present invention. It should be noted that a general computing device is not able to perform or deliver what the server 500 is equipped to do without the installation of or access to the server module 502.

According to one embodiment, the server module 502 comprises an administration interface 506, an account manager 508, a client manager 510, a security manager 512, an advertisement manager 514, a data processing module 516 and a payment manager 518.

### Administration Interface 506:

As the name suggests, the administration interface 506 facilitates a system administrator to access various components in the server module 502 and set up various parameters of the components. In one embodiment, a service provider uses the administration interface 506 to determine a spread for the payments received. For example, a carrier has decided to charge $2000 per shipment for transporting the shipment from A to B, the shipper will be billed for $2300, where the spread of $300 is split or shared among parties involved to facilitate the deal being completed. Should there be an advertiser hoping to advertise its goods or services (e.g., packing materials, LCL and FCL shipping services), the administration interface 506 is provided to manage such advertisements so that potential shippers may see such advertisements when they activate their computing devices.

### Account Manager 508:

The account manager 508 is provided to allow a user (e.g., a shipper or a carrier) to automatically register himself with the server 500 for a service being seeked or offered by the server 500 or register with a client module running on his mobile device, where the client module is designed to cause his mobile device to communicate with the server 500 via the interface 504. In one example, a user causes the client module to be executed for the first time on his device (e.g., iPhone), the module is designed to request the user to enter certain information (e.g., username/password, a fingerprint, a true name and etc.) before allowing the user to create a profile including an account for making or receiving payment. In one embodiment, a user is allowed to link his electronic wallet to his account. Whenever there is a payment to be made or received, the payment is made from or goes to his electronic wallet. Depending on the user, the profile may include an address (e.g., a warehouse address or a hub address), possible frequency of shipping goods and etc. After the registration, a profile of the user is created and then transported to the server 500.

### Client Manager 510

The client manager 510 is provided to manage versions of client modules provided to the users. In one embodiment, besides keeping updates to the client modules already downloaded by the users, there may be two versions of it, one for shippers, and the other for carriers. Depending on the implementation, these two versions of the client module may be implemented as a single module or two separate modules. In the context of the present invention, the client manager 510 controls when to switch from one version to another in accordance with a set of parameters about a user. In operation, the client manager 510 is notified which version or release a registered user is using.

### Security Manage 512

This module is configured to provide security when needed. The stored data for each of the subscribing businesses or registered users may be encrypted, thus only an authorized user may access the secured data. For example, all personal information of the users, especially the accounts set up by the users to make or receive payments are stored securely. In one embodiment, the security manage 512 is configured to initiate a secure communication session with a client device when a shipper makes a payment. In addition, the profile and preferences provided by the user are also secured by the security manager 512.

### Advertisement Manager 514

The advertisement manager 514 is a tool provided to allocate one or more advertisements for a user in accordance with his provided profile, where the advertisements are chosen based on certain criteria set by the service provider or/and the user. In addition, the service provider has also established the criteria based on a shipping history, types of goods shipped, possible needs and other considerations. For example, the advertisement manager 514 would never allocate pick-up services to a carrier, nor allocate advertisements not related to the shippers. In operation, the advertisement manager 514 is designed to periodically or constantly reallocate advertisements for each of the users based on a set of parameters to maximize the delivery and usefulness of the respectively allocated ads.

### Data Processing 516:

This module is configured to perform analytic operations to aggregate service information from carriers. As described above, a carrier in the business of providing LCL and FCL shipping services may periodically update its available freight schedules or rates. The data processing 516 is provided to receive this type of information and distribute them to shippers based upon their defined criteria (e.g., LCL and FCL shipping needs, types of trailers or containers, etc). In addition, the data processing 516 is provided to facilitate the communication of deal making between a shipper and a carrier. For example, when a carrier is interested in a shipping opportunity and makes a bid, the bid is processed by the data processing 516 is provided and presented to the shipper. Whenever the shipper makes a counter offer or revises his shipping request, the data processing 516 ensures that this particular carriers receives the offer prior to other carriers seeing it.

According to one embodiment, whenever such a transaction happens, the data processing module 516 is designed to calculate the remaining balance and take necessary procedure to collect the payment. Should there be a claim filed by a shipper against a carrier, the data processing 516 is engaged to process such a claim and ensure that the claim procedure is closed satisfactorily.

### Payment Manager 518:

As the name suggests, this module is designed to settle the payment between a shipper and a carrier. Depending on the situation, a shipper may have to pay a full amount before the shipment is taken, make several progressive payments based on the status of the shipment, or make a remaining balance payment upon the delivery of the shipment. All the fee schedules are controlled or monitored by the payment manager 518. In one embodiment, the payment manager 518 is designed to settle a payment electronically. In another embodiment, the payment manager 518 is designed to generate invoices automatically for the shippers or carriers (e.g., in a case of valid claim). In operation, this module works with the account manager 508 and the data processing unit 516 to ensure that a registered user fulfills his commitment when an mutually agreement is reached between two sides.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. The above description seems to focus on land transportation by a shipping company, those skilled in the art may appreciate that the same concept may also be applicable to shipping by other means, for example, cargo containers by ships, large or small, and shipping by individual cars. Accordingly, the scope of the present invention is defined by the appended claims rather than the foregoing description of embodiments.

We claim:

1. A method for facilitating a shipper and a carrier to reach a deal, the method comprising:
sending out a shipping request from a first computing device associated with the shipper, wherein the first computing device executes a client module specifically designed to receive inputs from the shipper, the inputs include a pick-up address and a delivery address, a fee, a profile of a shipment with a desired condition to handle the shipment from the shipper, the client module formulates the shipping request by including the inputs from the shipper and a timely-sensitive deadline;
receiving at least a bid from the carrier expressing an interest to transport the shipment, wherein the bid is a full acceptance of the shipping request or the bid is a counter offer from the carrier, the counter offer includes at least an amendment to some of the inputs from the shipper;
causing the shipper to view the bid; and
confirming the bid when the shipper agrees with the bid.

2. The method as recited in claim 1, further comprising:
displaying details of the shipping request on a second computing device associated with the carrier,
allowing the carrier to calculate a profit margin of transporting the shipment along an originally planned route;
receiving a bid prepared by the carrier when the carrier is interested in transporting the shipment for the shipper; and
causing the bid to be received by the shipper.

3. The method as recited in claim 2, further comprising: exchanging messages between the first and second computing devices to finalize an arrangement to pick up and deliver the shipment.

4. The method as recited in claim 1, wherein the shipment is a less container load (LCL).

5. The method as recited in claim 4, wherein the shipper desires to share a trailer or a container booked by a primary shipper and the trailer or the container is not fully occupied.

6. The method as recited in claim 5, further comprising: displaying a list of carriers providing available spaces in trailers or containers scheduled to deliver a set of goods, wherein there is an available space in each of the trailers or containers, the available space is made available for accommodating a shipment from a shipper looking for sharing the available space.

7. The method as recited in claim 5, further comprising:
displaying a list of carriers providing available spaces in trailers or containers scheduled to deliver a set of goods,
selecting to display details of one of the available spaces;
making a bid for the one of the available spaces; and
waiting for a confirmation from a carrier related to the one of the available spaces.

8. The method as recited in claim 1, wherein the profit margin of transporting the shipment along an originally planned route includes energy consumption along a specified route and an amount of impact thereof from terrines of the route.

9. The method as recited in claim 8, wherein the profit margin of transporting the shipment along an originally planned route further includes use of a profile of energy consumption along s planned route.

10. The method as recited in claim 1, further comprising:
allocating a set of advertisements per a profile of the shipper or the carrier; and
displaying the advertisements to the shipper or the carrier on a specific display when the shipper creates or the carrier responds to the shipping request.

11. A computing device for facilitating a shipper and a carrier to reach a deal, the computing device comprising:
a display screen;
a memory for storing a module;
a processor, coupled to the memory, caused to execute the module to perform operations of:
sending out a shipping request from the computing device associated with the shipper, wherein the computing device receives inputs from the shipper, the inputs include a pick-up address and a delivery address, a fee, a profile of a shipment with a desired condition to handle the shipment from the shipper, the shipping request is then formulated by including the inputs from the shipper and a timely-sensitive deadline;
receiving at least one bid from the carrier expressing an interest to transport the shipment, wherein the bid is a full acceptance of the shipping request or the bid is a counter offer from the carrier, the counter offer includes at least an amendment to some of the inputs from the shipper;
causing the shipper to view the bid; and
confirming the bid when the shipper agrees with the bid.

12. The computing device as recited in claim 11, wherein the operations further comprises: exchanging messages between the shipper and the carrier to finalize an arrangement to pick up and deliver the shipment.

13. The computing device as recited in claim 12, wherein the shipment is a less container load (LCL).

14. The computing device as recited in claim 13, wherein the shipper desires to share a trailer or a container booked by a primary shipper and the trailer or the container is not fully occupied.

15. The computing device as recited in claim 11, wherein the operations further comprises: displaying a list of carriers providing available spaces in trailers or containers scheduled to deliver a set of goods, wherein there is an available space in each of the trailers or containers, the available space is made available for accommodating a shipment from a shipper looking for sharing the available space.

16. The computing device as recited in claim 15, wherein the operations further comprises:
displaying a list of carriers providing available spaces in trailers or containers scheduled to deliver a set of goods,
selecting to display details of one of the available spaces;
making a bid for the one of the available spaces; and
waiting for a confirmation from a carrier related to the one of the available spaces.

17. The computing device as recited in claim 11, wherein the profit margin of transporting the shipment along an originally planned route includes energy consumption along a specified route and an amount of impact thereof from terrines of the route.

18. The computing device as recited in claim 17, wherein the profit margin of transporting the shipment along an originally planned route further includes use of a profile of energy consumption along s planned route.

19. The computing device as recited in claim 11, wherein the operations further comprises:
receiving a set of advertisements allocated per a profile of the shipper or the carrier; and
displaying the advertisements to the shipper or the carrier on a specific display when the shipper creates or the carrier responds to the shipping request.
